(19) United States
(12) Patent Application Publication
(10) Pub. No.: US 2025/0258995 A1
(43) Pub. Date: Aug. 14, 2025

(54) MANAGING COMMENTS IN AN ANALYTIC APPLICATION

(71) Applicant: SAP SE, Walldorf (DE)

(72) Inventor: Archana Shridhar, Bangalore (IN)

(21) Appl. No.: 18/601,680

(22) Filed: Mar. 11, 2024

Related U.S. Application Data
(60) Provisional application No. 63/552,060, filed on Feb. 9, 2024.

(51) Int. Cl. G06F 40/169

(52) U.S. Cl. CPC G06F 40/169

(57) ABSTRACT

Embodiments of the present disclosure include techniques for managing comments. In one embodiment, a comment is associated with a data field generated based on filter parameters and access rights. Comment context is generated from the filter parameters and access rights and stored in a database. The access rights may comprise Boolean operations on members of certain dimensions, including an OR operation. Comment context may be stored as a flat file, where dimension members are associated to indicate filter parameters and access rights used to generate the comment.

### CROSS REFERENCE TO RELATED APPLICATIONS

This Application claims priority to U.S. Provisional Patent Application No. 63/552,060 filed on Feb. 9, 2024, the contents of which are hereby incorporated herein by reference.

### BACKGROUND

The present disclosure relates generally to analytic software, and in particular, to systems and methods for managing comments in an analytic software application.

Computer systems can be configured to provide analytic software applications to support analysis of data in a database. An analytic software application allows users to perform a variety of actions related to the data contained in the database, including data analysis, data reporting, and data manipulation, for example. Different users may leverage other capabilities of the analytic software application to collaborate with one another. Such collaboration often includes storing comments regarding the data provided by different users. However, different users may have different access rights. Managing comments from a landscape of users with different access rights to the data can be a challenge.

The present disclosure addresses these and other challenges and is directed to techniques for managing comments in an analytic software application.

### BRIEF DESCRIPTION OF THE DRAWINGS

FIG. 1 illustrates a system for managing comments in an analytic software application according to an embodiment.

FIG. 2 illustrates a method for managing comments in an analytic software application according to an embodiment.

FIG. 3A illustrates an example filter according to an embodiment.

FIG. 3B illustrates an example access rights specifying accessible dimensions according to an embodiment.

FIG. 3C illustrates a filtered data field and filtered dimensions according to an embodiment.

FIG. 3D illustrates an example data field and corresponding dimensions members according to an embodiment.

FIG. 3E illustrates an example data field and corresponding dimensions members according to another embodiment.

FIG. 3F illustrates an example comment and comment context according to an embodiment.

FIG. 4A illustrates another example data field and filter parameters according to another embodiment.

FIG. 4B illustrates yet another example data field and filter parameters according to another embodiment.

FIG. 4C illustrates an example comment context according to an embodiment.

FIG. 5 illustrates a method of generating comment context according to an embodiment.

FIG. 6 illustrates hardware of a special purpose computing system configured according to the above disclosure.

### DETAILED DESCRIPTION

Described herein are techniques for managing comments in an analytic software application. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

Typically, data accesses act as dynamic and varying filters to different data cells of the same table, making the calculation of data context complex. Managing comments from a landscape of users with such a complex data access rights across multiple dimensions requires specific capabilities of data structure. For a static filter, for example, a flat structure can be used for a single dimension. However, for a dynamic filter (e.g., OR condition), a flat structure may be leveraged using multi-dimensional capabilities with OR condition.

FIG. 1 illustrates a system for managing comments in an analytic software application according to an embodiment. Features and advantages of the present disclosure include storing and managing comments across an analytic software system where different users have different access rights to the data being analyzed. Computer system 100 may execute an analytic software application 101, which accesses data in one or more databases 102. Computer system 100 may comprise one or more computers coupled together over a network. Computers may include client computers that interface with users 190 and server computers (e.g., backend servers implemented on a cloud server system, on-premises, or a combination thereof) that store and retrieve data from database 102, interface with client computers, and perform the various data processing functions, including the features and functions described herein.

Data is stored in database 102. The data may comprise numerous tables, for example, and include dimensions and values (aka, facts). Values are typically numeric measures of an item (e.g., sales, time, etc. . . . ). Dimensions describe the values. Dimensions may include reference information about the values. Each dimension may have multiple unique descriptors (aka, members), and each member may have multiple sub-members. An example dimension is location, where members for location may include US and Canada, and members for US may include states, which may also have sub-members (e.g., cities). Accordingly, dimensions may form hierarchies of members for classifying particular data fields, and the hierarchies may for parent member-child member relationships (e.g., US-CA, where US is the parent member and CA is the child member). One or more members of multiple different dimensions may be used to aggregate data and produce a filtered data field (e.g., generate sales for Location (CA(SF)), Product (Beer)). Dimensions may be stored in a dimension table whereas facts may be stored in fact table, for example. Users 190 typically have different access rights that limit the dimensions and values a user may have access to. Dimensions that a user has access to are referred to herein as accessible dimensions. Accordingly, users may have limited access rights that limit access to accessible dimensions of the plurality of dimensions available in one or more databases 102.

Users may analyze data by specifying filters that produce subsets of data of interest. Accordingly, analytics software application 101 may receive filter parameters 104 specifying a subset of data stored in database 102. The filter parameters 104 specify filtered dimensions of one or more of a plurality of dimensions of the data to produce a filtered data field. For example, a user may specify a filter that aggregates gross margin across one or more regions for particular products. The results may be a particular value produced by adding sales for specified products across the specified regions, for example. Once the filter is defined, the user may monitor how the generated value in the filtered data field changes over time as the source data changes, for example. However, because a particular user may have limited access rights, when the filtered data field is provided to the user, the filtered data field may be generated based on limited access to accessible dimensions. Accordingly, another user with different access rights (e.g., to additional members of one or more dimensions) may execute the same filter and see a different value in the filtered data field, for example. If one user with one set of access rights adds a comment to the filtered data field, the comment may not make sense for another user with different access rights because the dimension members being used to generate the filtered data field may be different.

Advantageously, features and advantages of the present disclosure store comments based on filter parameters and access rights. For instance, a user with particular access rights may associate a comment 111a with a particular filtered data field 110a produced based on filter parameters 104 and access rights 103. A comment context generator 112 may generate comment context 120 that is associated with comment 111a, for example, based on the filter parameters 104 and access parameters 103 for the particular user. Comment context 120 specifies at least a portion of the filtered dimensions and the accessible dimensions used to produce the filtered data field 110a associated with the comment 111a. Accordingly, a user may associate a plurality of data fields 110a-n with comments 111a-n and comment context generator 112 produces comment context 120. Particular comments are associated with corresponding comment context and stored in a comments database 130. In some embodiments, comments and associated context are stored in the same database as the data, and in other embodiments comments and associated context are stored in different databases.

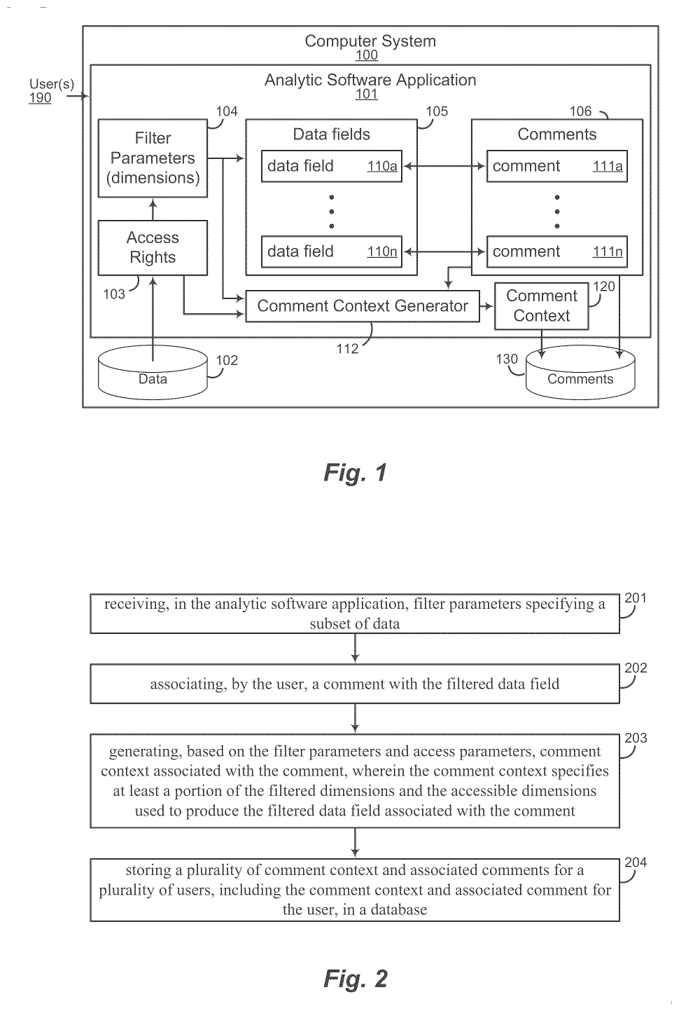

FIG. 2 illustrates a method for managing comments in an analytic software application according to an embodiment. At 201, an analytic software application receives filter parameters specifying a subset of data. The filter parameters may specify filtered dimensions of one or more of a plurality of dimensions of the data to produce a filtered data field. The filtered data field may be provided to a user having access rights that limit access to accessible dimensions of the plurality of dimensions. At 202, a comment is associated with the filtered data field (e.g., by a user). At 203, comment context is generated based (at least in part) on the filter parameters and access parameters and associated with the comment. The comment context specifies at least a portion of the filtered dimensions and the accessible dimensions used to produce the filtered data field associated with the comment. At 204, a plurality of comment context and associated comments for a plurality of users, including the comment context and associated comment for the user, are stored in a database.

### ILLUSTRATIVE EXAMPLES

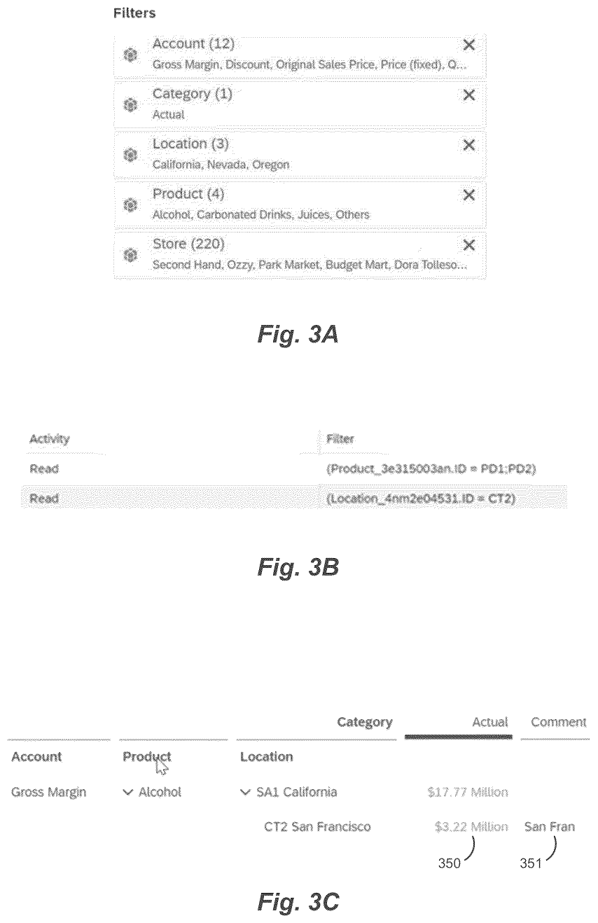

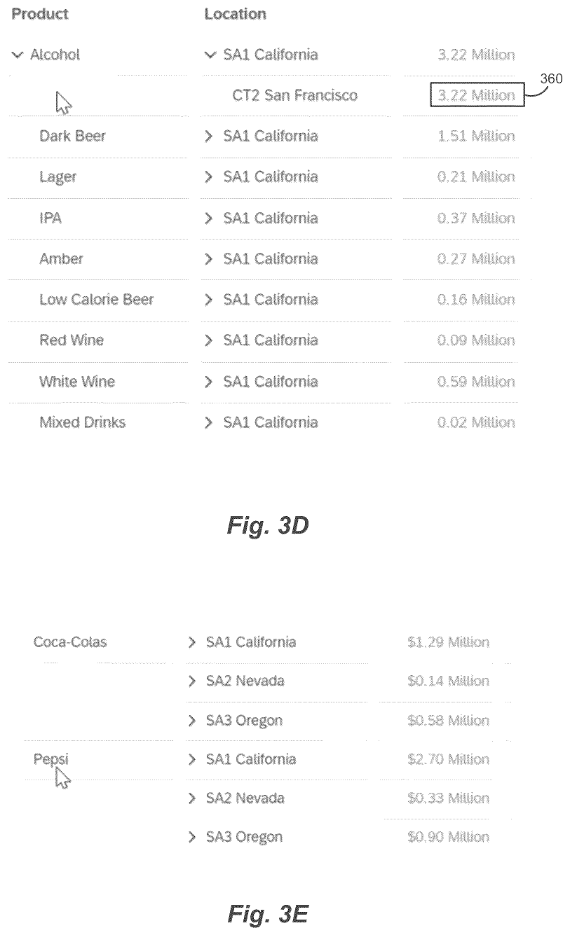

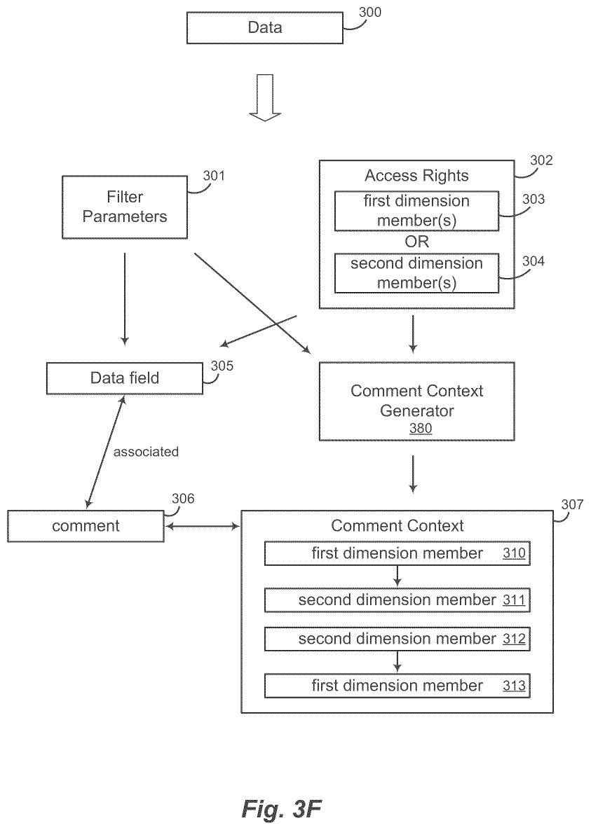

FIG. 3A illustrates an example filter according to an embodiment. In this example, the filter dimensions are account, category, location, product, and store. The members of the account dimension are Gross Margin, Discount, Original Sales Price, Price (fixed), etc. . . . . The members of location dimension are California, Nevada, Oregon. The members of the product dimension are Alcohol, Carbonated Drinks, Juices, and others. The members the store dimension are Second Hand, Ozzy, Part Market, etc. . . . . Each member of each dimension may further have one or more layers of sub-members (e.g., California(NorthernCA(city1, city2, etc. . . . ))). A user may select one or more of the members (or sub-members) of each dimension to retrieve particular data from a database, for example. The user may then filter on location (e.g., California), product (e.g., Coke and Pepsi), and store (e.g., Park Market) to obtain sales of Coke and Pepsi at all Park Market stores in California, for example.

FIG. 3B illustrates an example access rights specifying accessible dimensions according to an embodiment. In this example, a user has been assigned access rights to products PD1 (Coke) and PD2 (Pepsi). Separately, the user has been assigned access rights to location CT2 (San Francisco, “SF”). In this example, the user access rights for the following Boolean operation: SF OR (Coke OR Pepsi), which specify accessible dimensions for the user.

FIG. 3C illustrates a filtered data field and filtered dimensions according to an embodiment. In this example, the filtered dimensions are Account=Gross Margin, Product=Alcohol, and Location=SF. The total sales for these filter parameters are in the filtered data field 350. The total for the current data in the underlying tables is $3.22 Million. A comment has been added at 351 (“San Fran”)

FIG. 3D illustrates an example data field and corresponding dimensions members according to an embodiment. For OR condition permissions limiting members to first dimension members (e.g., Product=[Coke OR Pepsi]) OR second dimension members (e.g., Location=SF), a user is given access to all first dimensions members (Coke,Pepsi,Dark Beer, Lager, IPA, etc. . . . ) within limited second dimension members (SF). For instance, the filtered data field 360 includes all product sales for San Francisco as a result of the OR condition in the access rights (e.g., SF OR (Coke OR Pepsi)).

FIG. 3E illustrates an example data field and corresponding dimensions members according to another embodiment. This example illustrates another outcome for an OR condition. Here, the user is given access to limited first dimension members (Product=[Coke OR Pepsi]) across all second dimension members (Location=[CA,OR,NV]). For example, the user is given access to limited first dimension members (Coke/Pepsi) across all second dimensions (Location=[CA, OR, NV]).

FIG. 3F illustrates an example comment and comment context according to an embodiment. Embodiments disclosed herein generate comment context to capture these conditions so that comments may be stored with comment context that uniquely specifies the data field. Comments may then be retrieved such that the comment is matched with appropriate data field. In this example, filter parameters 301 are specified by a user. The user has access rights 302 comprising a Boolean OR operation of one or more first dimension members 303 OR one or more second dimensions members 304. Data 300 is filtered based on access rights 302 and filter parameters 301 to produce a data value in a data field 305. Data field 305 may be associated with a comment. Comment context generator 380 analyzes the filter parameters and access rights to produce comment context 307. Comment context generator 380 may retrieve the access rights for the user, including dimension members and Boolean operations. Comment context generator 380 may retrieve the filter parameters 301, including specified dimension members for multiple dimensions. Comment context generator 380 may determine, based on the Boolean operations, members of each dimension to be included in the comment context 307 as well as associations between members to specify access right limitations. For example, the comment context 307 may include one or more first dimension members 310 associated with second dimension members 311 for OR operation cases where the user is given access to all first dimension members (Coke, Pepsi, Dark Beer, Lager, IPA, etc. . . . ) within limited second dimension members (SF) as mentioned above. Similarly, the comment context 307 may include one or more second dimension members 312 associated with first dimension members 313 for OR operation cases where the user given access to limited first dimension members (Coke/Pepsi) across all second dimensions (Location=[CA, OR, NV]) as mentioned above. Accordingly, an analytic software system may store the comment 306 and comment context 307 in a separate database and advantageously retrieve and match a comment to a particular data field based on specified filter parameters and access rights.

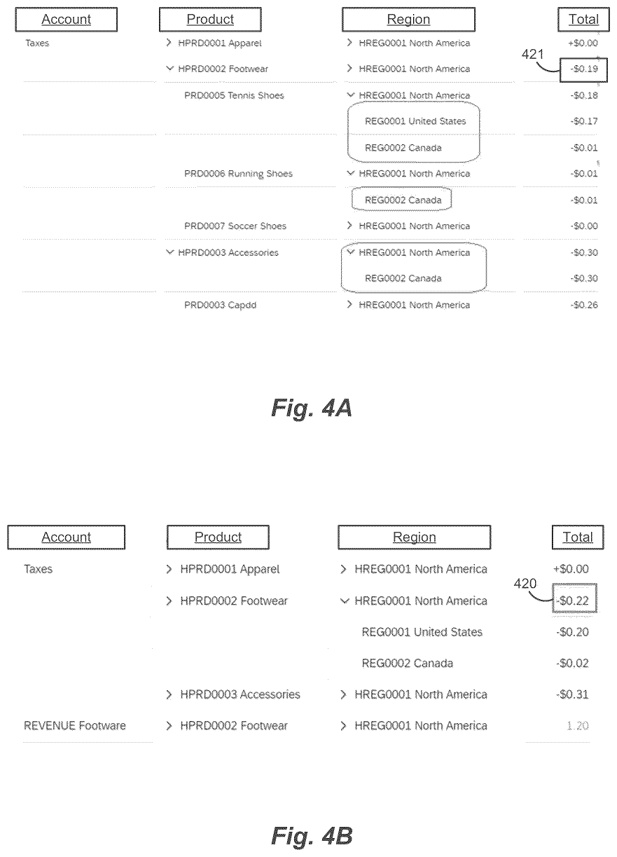

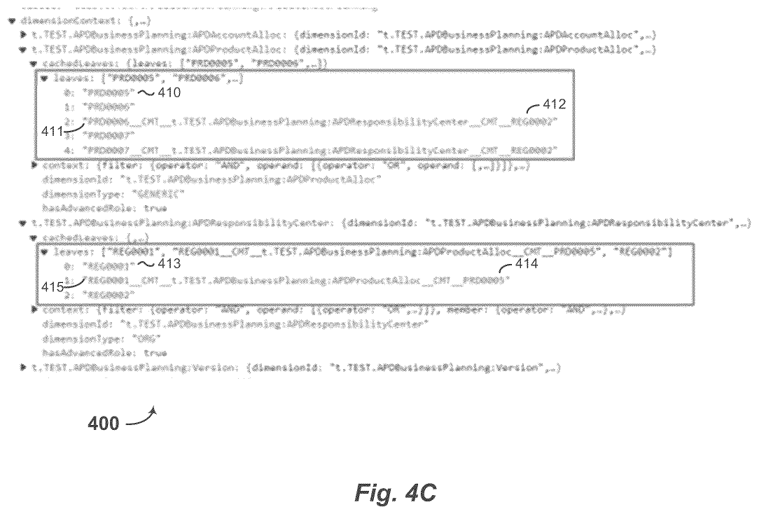

FIG. 4A illustrates another example data field and filter parameters according to another embodiment. As mentioned above, certain embodiments may access rights that specify a logical OR operation of a first dimension sub-members and second dimension sub-members associated with the filtered data field. In this example, a user may have access right associated with a Region dimension set to REG0002 (Region=Canada) OR Product dimension set to PRD0001 OR PRD0005 (e.g., Product=Athletic Shirts OR Tennis Shoes). Accordingly, the table in FIG. 4A shows Product and Region columns with the filter parameters set for North America for Region and Apparel, Footwear & Accessories for Product. However, since the user access is set to REG0002 OR (PRD0001 OR PRD0005), which corresponds to Region Canada OR (Athletic Shirts, Tennis Shoes), the data cells associated with either of them are being rendered in the table. Here the additional dimension members coming via the role are generated dynamically and depend on the presence of one of the accessible dimensions members that form the coordinates for the data aggregation. For instance, because the user has access to Canada, data for running shoes (e.g., in Canada) and Accessories (e.g., in Canada) are included. Additionally, data for Tennis shoes over North America includes all the sub members (United states & Canada), whereas data for Running shoes over North America includes only Canada. The same is the case with Accessories over North America. As the defined user's access in the first dimension does not include any sub member of Accessories, the data aggregation happens with accesible members from the second dimension which is only Canada.

FIG. 4B illustrates yet another example data field and filter parameters according to another embodiment. This example illustrates comment context for comments associated with data fields having different aggregations is uniquely maintained. Accordingly, generating comment context may include determining a unique set of first dimension sub-members and second dimension sub-members associated with the filtered data field. FIG. 4B illustrates that dimension members involved in the data aggregation could look similar to the ones returned for Admin user having full data access. But the data aggregation would be different. FIG. 4B illustrates data for an administrative user with wider access rights than the user in FIG. 4A. Here, the total for Footwear in North America, at 420, is a different value than the total for Footwear in North America, at 421, due to the wider access rights. For example, Admin user data aggregation for Footwear over North America includes data of all the sub members of Footwear over all the sub members of North America, whereas for a user with specific access like REG0002 OR (PRD0001 OR PRD0005), which corresponds to Region Canada OR (Athletic Shirts, Tennis Shoes), data aggregation includes Athletic Shoes & Tennis Shoes over all the sub members of North America and Running shoes over Canada only.

FIG. 4C illustrates an example comment context for the example in FIG. 4A according to an embodiment. In this example, the comment context is a flat data structure comprising one or more of the filtered dimensions associated with one or more of the accessible dimensions for the user. The comment context 400 comprises a dimension member 410 (PRD0005—Tennis Shoes) of the filtered dimensions included in the access rights, a dimension member 411 (PRD0006—Running Shoes) of the filtered dimensions not included in the access rights associated with corresponding dimension member 412 (REG0002—Canada) of the filtered dimensions included in the access rights. Additionally, comment context 400 includes dimension member 413 (REG0001—United States) of the filtered dimensions not included in the access rights associated with corresponding dimension member 414 (PRD0005—Tennis Shoes) of the filtered dimensions included in the access rights. Comment context generator generates context member by member by determining and including members of other dimensions. Advantageously, the members in the comment context with conditional access are delineated through the association to another member in the form of flat file list. As mentioned above, the user does not have permission to access PRD0006—Running Shoes, but access to PRD0006 is allowed through REG0002—Canada. The association of REG0002 to PRD0006 in the comment context captures this condition. Similarly, the user does not have permission to access REG0001—United States, but access to REG0001 is allowed through PRD0005—Tennis Shoes, for example, as described above. The association of REG0001 to PRD0005 in the comment context captures this condition.

As illustrated in this example, dimension members may be stored as text, and one dimension member may be appended to another dimension member to capture the above mentioned conditions. For example, dimension member 410-411 are associated with the Product dimension and are stored as text. Similarly, dimension member 412 associated with the Region dimension is stored as text. Dimension member 412 is appended to dimension member 411, and dimension member 414 is appended to dimension member 415.

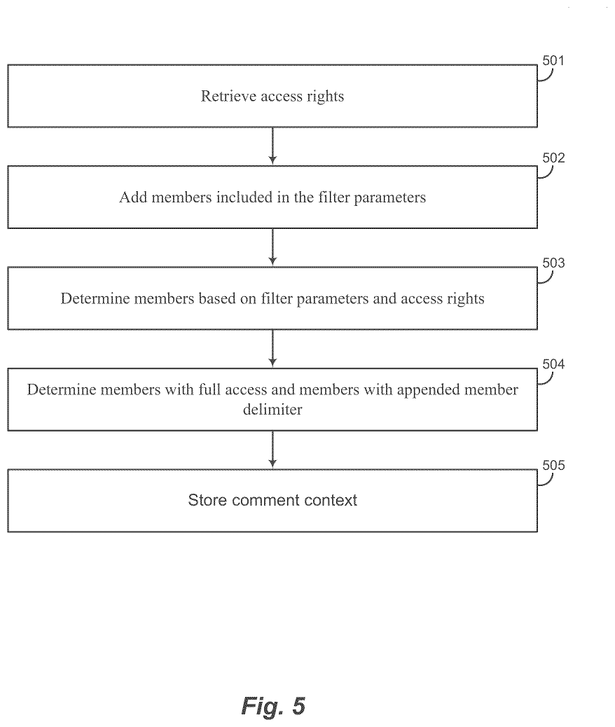

FIG. 5 illustrates a method of generating comment context according to an embodiment. At 501, access rights are retrieved. For example, data access filter based on the user's role name can be retrieved from the table (e.g. xxx.yyy.services.security::Security.DataAccessFilter_as follows:

```
SELECT ″FILTER″
  FROM ″${schema}″.″xxx.yyy.services.security::Security.DataAccessFilter_″
    WHERE ″CUBE_NAME″ = ? AND ″USER_NAME″ = ?‘;
```

The result may be as follows:
“REGION.ID”=‘REG0002’ OR “PRODUCT.ID” IN (‘PRD0001’, ‘PRD0005’)

At 502, the members included in the filter parameters are added to the context. For example, the members (e.g., children of a datapoint) that are part of table filter of every dimension may be added to temporary tables as follows:

```
const sCreateTableSQL = ‘CREATE LOCAL TEMPORARY TABLE ${sTempTable}
(MEMBER_ID NVARCHAR (256) );‘;
this.connection.executeUpdate(sCreateTableSQL);
      const sInsertSQL = ‘INSERT INTO ${sTempTable} values(?);‘;
if ( aRowData.length > 0) {
      var pstmtInsert = this.connection.prepareStatement(sInsertSQL);
      aRowData.forEach(id => {
        pstmtInsert.setString(1, id);
        pstmtInsert.addBatch( );
    });
  pstmtInsert.executeBatch( );
  pstmtInsert.close( );
  this.connection.commit( );
}
```

At 503, members are determined based on filter parameters and assigned rights. For example, the context generator may generate effective dynamic members based on access rights and entries in temporary table for each dimension that is part of the role based data access as follows:

```
let roleCteName = ″roleCmt″;
let roleCte = ‘${roleCteName} AS (SELECT‘ + aDimensionIds.map((dimId) => {
let newDimId = dimId.split(′:′);
let resultDimId = newDimId[newDimId.length−1]+″.ID″;
    return ‘″${resultDimId}″‘;
  }).join(″,″) + ″ FROM ″+
aDimensionIds.map((dimId) => ‘″${schema}″.″${dimId}″‘).join(″, ″)+″ WHERE (″
+roleInfo.filters.map((filter) => ″(″+filter+″)″).join(″ OR ″) +″))″;
WhereClause = aDimensionIds.filter(dId => dimensionContext.hasOwnProperty(dId) &&
dimensionContext[dId].cachedLeaves).map((dimId) => {
    let newDimId = dimId.split(′:′);
    let resultDimId = newDimId[newDimId.length−1]+″.ID″;
    let sTempTable = ‘#CMT_‘+newDimId[newDimId.length−1];
    return ‘″${resultDimId}″ IN (SELECT MEMBER_ID FROM ${sTempTable})‘;
  }).join(″ AND ″);
WhereClause = WhereClause.length > 0 ? ″ WHERE ″ + WhereClause : ″″;
```

When generating effective dynamic members of Product for a comment added on Footwear for North America, the resulting Query may look like the following:
WITH roleCmt AS (SELECT APDResponsibilityCenter.ID FROM “TENANT_TEST”. “t.TEST.APDBusinessPlanning:APDResponsibilityCenter”, “TENANT_TEST”. “t.TEST.APDBusinessPlanning:APDProductAlloc WHERE “APDResponsibilityCenter.ID”=‘REG0002’ OR “APDProductAlloc.ID” IN (‘PRD0001’, ‘PRD0005’)) (SELECT*FROM roleCmt WHERE APDProductAlloc.ID IN (SELECT MEMBER_ID FROM #CMT_ APDProductAlloc) ORDER BY APDProductAlloc.ID)

At 504, members are determined with full access and with appended member delimiters for limited access. For example, from the obtained result set, Iterate through each member for the target dimension for which final dynamic members must be generated and run it through the example script below. If the result set row for member A of Product has been returned for all the members of Region temp table, then member A has fullAccess. If not then, a new entry for member A with delimiter_CMT_associated with returned members of Region will be added to the member list. The following algorithm is an example:

```
Object.keys(roleCxtLeaves).forEach(roleDimId => {
  let leaves = [ ];
  if(dimensionContext[roleDimId] && dimensionContext[roleDimId].cachedLeaves){
    leaves = isSave?dimensionContext[roleDimId].cachedLeaves.leaves :
dimensionContext[roleDimId].cachedLeaves;
  }
  var roleMemCnt = roleCxtLeaves[roleDimId].length;
  if(roleContext[roleDimId].totalMemberCnt != roleMemCnt &&
(!(dimensionContext[roleDimId] && dimensionContext[roleDimId].cachedLeaves) ||
roleMemCnt < leaves.length)){
    var added = 0;
    roleCxtLeaves[roleDimId].forEach(memId => {
      let valStr = prev + ‘ _{——}CMT_{——}’ + roleDimId + ‘_{——}CMT_{——}’ + memId;
      if(!roleContext[dimensionId][0].values.includes(valStr)){
        if(!(dimensionContext[roleDimId] &&
dimensionContext[roleDimId].cachedLeaves) || leaves.length > 1){
          roleContext[dimensionId][0].values.push(valStr);
        }
        added = true;
```

Once the iteration is completed for all the resulted members of all the dimensions involved in access rights, the final set of members are generated to represent the applied comment context.

Advantages of various embodiments include a unique solution in terms of data representation based on dynamic data filters across multiple dimension which enables the system to distinguish data/comment context for the same cell for different users with different level of access. The techniques described herein are applicable for complicated data access that may include multiple dimensions with both AND and OR conditions, such as, for example, the following:
(“APDResponsibilityCenter.ID”=‘REG0002’ AND APDAccountAlloc.ID in (‘SALESEXP’, ‘DISCOUNTS’)) OR “APDProductAlloc.ID” IN (‘PRD0001’, ‘PRD0005’) OR (“VERSION.ID”=‘Budget’ AND APDAccountAlloc.ID in (‘TAXES’, ‘QUANTITYSOLD’))

The technique described herein also address usage of properties instead of ID if properties are defined for given dimension. For example, using AccType property instead of ID for AccountAlloc:
(“APDResponsibilityCenter.ID”=‘REG0002’ AND APDAccountAlloc.AccType=‘EXP’) OR “APDProductAlloc.ID” IN (‘PRD0001’, ‘PRD0005’) OR (“VERSION.ID”=‘Budget’ AND APDAccountAlloc.ID in (‘TAXES’, ‘QUANTITYSOLD’))

Usage of EffectiveDataAccessFilter which is part of an analytic model as a condition for the where clause makes the context generation accurate and close to the data aggregation. Additionally, usage of temporary tables in the in-clause of the query makes the context generation much faster.

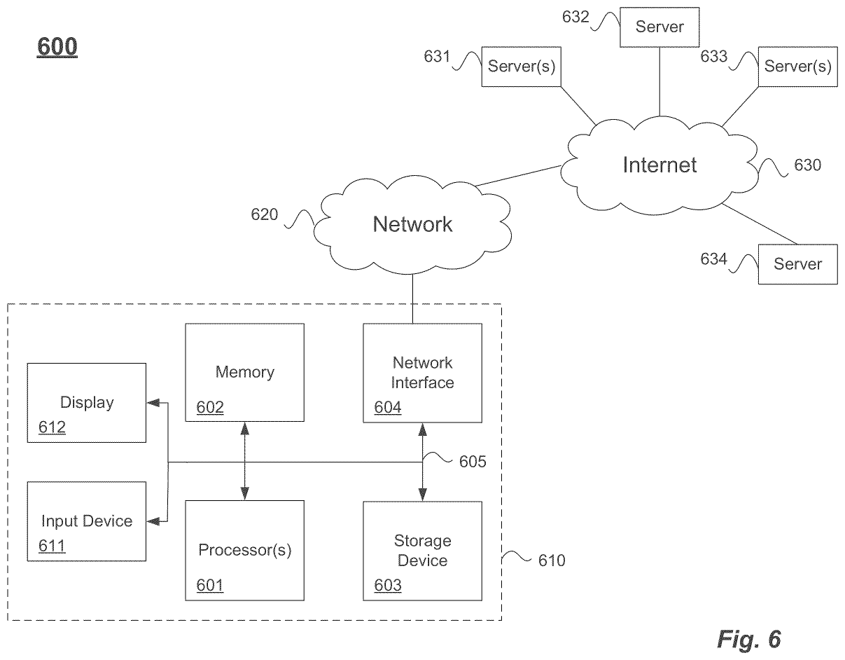

FIG. 6 illustrates hardware of a special purpose computing system 600 configured according to the above disclosure. The following hardware description is merely one example. It is to be understood that a variety of computers topologies may be used to implement the above-described techniques. An example computer system 610 is illustrated in FIG. 6. Computer system 610 includes a bus 605 or other communication mechanism for communicating information, and one or more processor(s) 601 coupled with bus 605 for processing information. Computer system 610 also includes memory 602 coupled to bus 605 for storing information and instructions to be executed by processor 601, including information and instructions for performing some of the techniques described above, for example. Memory 602 may also be used for storing programs executed by processor(s) 601. Possible implementations of memory 602 may be, but are not limited to, random access memory (RAM), read only memory (ROM), or both. A storage device 603 is also provided for storing information and instructions. Common forms of storage devices include, for example, a hard drive, a magnetic disk, an optical disk, a CD-ROM, a DVD, solid state disk, a flash or other non-volatile memory, a USB memory card, or any other electronic storage medium from which a computer can read. Storage device 603 may include source code, binary code, or software files for performing the techniques above, for example. Storage device 603 and memory 602 are both examples of non-transitory computer readable storage mediums (aka, storage media).

In some systems, computer system 610 may be coupled via bus 605 to a display 612 for displaying information to a computer user. An input device 611 such as a keyboard, touchscreen, and/or mouse is coupled to bus 605 for communicating information and command selections from the user to processor 601. The combination of these components allows the user to communicate with the system. In some systems, bus 605 represents multiple specialized buses for coupling various components of the computer together, for example.

Computer system 610 also includes a network interface 604 coupled with bus 605. Network interface 604 may provide two-way data communication between computer system 610 and a local network 620. Network 620 may represent one or multiple networking technologies, such as Ethernet, local wireless networks (e.g., WiFi), or cellular networks, for example. The network interface 604 may be a wireless or wired connection, for example. Computer system 610 can send and receive information through the network interface 604 across a wired or wireless local area network, an Intranet, or a cellular network to the Internet 630, for example. In some embodiments, a frontend (e.g., a browser), for example, may access data and features on backend software systems that may reside on multiple different hardware servers on-prem 631 or across the network 630 (e.g., an Extranet or the Internet) on servers 632-634. One or more of servers 632-634 may also reside in a cloud computing environment, for example.

### FURTHER EXAMPLES

Each of the following non-limiting features in the following examples may stand on its own or may be combined in various permutations or combinations with one or more of the other features in the examples below. In various embodiments, the present disclosure may be implemented as a system, method, or computer readable medium.

Embodiments of the present disclosure may include systems, methods, or computer readable media. In one embodiment, the present disclosure includes computer system comprising: at least one processor and at least one non-transitory computer readable medium (e.g., memory) storing computer executable instructions that, when executed by the at least one processor, cause the computer system to perform a method as described herein and in the following examples. In another embodiment, the present disclosure includes a non-transitory computer-readable medium storing computer-executable instructions that, when executed by at least one processor, perform a method as described herein and in the following examples.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A method of managing comments in an analytic software application comprising:
receiving, in the analytic software application, filter parameters specifying a subset of data, the filter parameters specifying filtered dimensions of one or more of a plurality of dimensions of the data to produce a filtered data field, wherein the filtered data field is provided to a user having access rights that limit access to accessible dimensions of the plurality of dimensions;
associating, by the user, a comment with the filtered data field;
generating, based on the filter parameters and access parameters, comment context associated with the comment, wherein the comment context specifies at least a portion of the filtered dimensions and the accessible dimensions used to produce the filtered data field associated with the comment; and
storing a plurality of comment context and associated comments for a plurality of users, including the comment context and associated comment for the user, in a database.

2. The method of claim 1, wherein the comment context is a flat data structure comprising one or more of the filtered dimensions associated with one or more of the accessible dimensions for the user.

3. The method of claim 1, wherein the filtered dimensions comprise:
a first dimension comprising one or more first dimension members, wherein one or more of the first dimension members comprise a plurality of first dimension sub-members; and
a second dimension comprising one or more second dimension members, wherein one or more of the second dimension members comprise a plurality of second dimension sub-members,
wherein generating comment context comprises determining a unique set of first dimension sub-members and second dimension sub-members associated with the filtered data field.

4. The method of claim 3, wherein access rights specify a logical OR operation of the first dimension sub-members and the second dimension sub-members associated with the filtered data field.

5. The method of claim 1, wherein the comment context comprises:
one or more first members of the filtered dimensions included in the access rights;
one or more second members of the filtered dimensions not included in the access rights associated with corresponding one or more third members of the filtered dimensions included in the access rights; and
one or more fourth members of the filtered dimensions not included in the access rights associated with corresponding one or more fifth members of the filtered dimensions included in the access rights.

6. The method of claim 5, wherein:
the one or more second members correspond to a first dimension of the plurality of dimensions and the associated one or more third members correspond to a second dimension of the plurality of dimensions; and
the one or more fourth members correspond to the first dimension and the associated one or more fifth members correspond to the second dimension.

7. The method of claim 1, wherein the accessible dimensions comprise first access parameters logically combined with second access parameters.

8. The method of claim 7, wherein the first access parameters are combined with the second access parameters using a logical OR operation.

9. The method of claim 8, wherein the comment context comprises:
a first dimension member associated with a first dimension stored as text;
a second dimension member associated with a second dimension stored as text;
a third dimension member associated with the second dimension stored as text; and
a fourth dimension member associated with the first dimension stored as text,
wherein the second dimension member is appended to the first dimension member, and the fourth dimension member is appended to the third dimension member.

10. A computer system comprising:
at least one processor;
at least one non-transitory computer readable medium storing computer executable instructions that, when executed by the at least one processor, cause the computer system to perform a method comprising:
receiving, in an analytic software application, filter parameters specifying a subset of data, the filter parameters specifying filtered dimensions of one or more of a plurality of dimensions of the data to produce a filtered data field, wherein the filtered data field is provided to a user having access rights that limit access to accessible dimensions of the plurality of dimensions;
associating, by the user, a comment with the filtered data field;
generating, based on the filter parameters and access parameters, comment context associated with the comment, wherein the comment context specifies at least a portion of the filtered dimensions and the accessible dimensions used to produce the filtered data field associated with the comment; and
storing a plurality of comment context and associated comments for a plurality of users, including the comment context and associated comment for the user, in a database.

11. The computer system of claim 10, wherein the comment context is a flat data structure comprising one or more of the filtered dimensions associated with one or more of the accessible dimensions for the user.

12. The computer system of claim 10, wherein the filtered dimensions comprise:
a first dimension comprising one or more first dimension members, wherein one or more of the first dimension members comprise a plurality of first dimension sub-members; and
a second dimension comprising one or more second dimension members, wherein one or more of the second dimension members comprise a plurality of second dimension sub-members,
wherein generating comment context comprises determining a unique set of first dimension sub-members and second dimension sub-members associated with the filtered data field.

13. The computer system of claim 12, wherein access rights specify a logical OR operation of the first dimension sub-members and the second dimension sub-members associated with the filtered data field.

14. The computer system of claim 10, wherein the comment context comprises:
one or more first members of the filtered dimensions included in the access rights;
one or more second members of the filtered dimensions not included in the access rights associated with corresponding one or more third members of the filtered dimensions included in the access rights; and
one or more fourth members of the filtered dimensions not included in the access rights associated with corresponding one or more fifth members of the filtered dimensions included in the access rights.

15. The computer system of claim 10, wherein the accessible dimensions comprise first access parameters logically combined with second access parameters.

16. A non-transitory computer-readable medium storing computer-executable instructions that, when executed by at least one processor, perform a method of managing comments in an analytic software application, the method comprising:
receiving, in the analytic software application, filter parameters specifying a subset of data, the filter parameters specifying filtered dimensions of one or more of a plurality of dimensions of the data to produce a filtered data field, wherein the filtered data field is provided to a user having access rights that limit access to accessible dimensions of the plurality of dimensions;
associating, by the user, a comment with the filtered data field;
generating, based on the filter parameters and access parameters, comment context associated with the comment, wherein the comment context specifies at least a portion of the filtered dimensions and the accessible dimensions used to produce the filtered data field associated with the comment; and
storing a plurality of comment context and associated comments for a plurality of users, including the comment context and associated comment for the user, in a database.

17. The non-transitory computer-readable medium of claim 16, wherein the comment context is a flat data structure comprising one or more of the filtered dimensions associated with one or more of the accessible dimensions for the user.

18. The non-transitory computer-readable medium of claim 16, wherein the filtered dimensions comprise:
a first dimension comprising one or more first dimension members, wherein one or more of the first dimension members comprise a plurality of first dimension sub-members; and
a second dimension comprising one or more second dimension members, wherein one or more of the second dimension members comprise a plurality of second dimension sub-members,
wherein generating comment context comprises determining a unique set of first dimension sub-members and second dimension sub-members associated with the filtered data field.

19. The non-transitory computer-readable medium of claim 16, wherein the comment context comprises:
one or more first members of the filtered dimensions included in the access rights;
one or more second members of the filtered dimensions not included in the access rights associated with corresponding one or more third members of the filtered dimensions included in the access rights; and
one or more fourth members of the filtered dimensions not included in the access rights associated with corresponding one or more fifth members of the filtered dimensions included in the access rights.

20. The non-transitory computer-readable medium of claim 16, wherein the accessible dimensions comprise first access parameters logically combined with second access parameters.
